(19) United States
(12) Patent Application Publication
(10) Pub. No.: US 2017/0108082 A1
(43) Pub. Date: Apr. 20, 2017

(54) LINE GUIDE DEVICE WITH ONE-PIECE HINGE, A CORRESPONDING CHAIN LINK AND A HINGE BAND

(71) Applicant: igus GmbH, Koln (DE)

(72) Inventor: Dominik BARTEN, Mechenheim (DE)

(21) Appl. No.: 15/129,232

(22) PCT Filed: Mar. 23, 2015
(86) PCT No.: PCT/EP15/56123

§ 371 Date: Sep. 26, 2016

(30) Foreign Application Priority Data
Mar. 24, 2014 (DE) 20 2014 101 366.0

(51) Int. Cl. F16G 13/16; H02G 11/00

(52) U.S. Cl. CPC F16G 13/16; H02G 11/006

(57) ABSTRACT

A line guide device, especially an energy chain, for guiding cables, hoses or the like is proposed. It includes a plurality of links or segments connected together and made from plastic and hast at least one one-piece hinge (20; 40). The one-piece hinge (20, 40) can be provided for connecting two links or segments (45) together, which are adjacent in the longitudinal direction and which are pivotable relative to each other by the hinge (40) and/or for connecting two parts of a single link or segment, e.g. for connecting a transverse web (14) to a side portion (11) in such a way that the transverse web (14) can be opened.

According to the invention, the one-piece hinge (20; 30; 40; 50) is of a lattice-like structure with a plurality of openings (22, 23; 32, 33; 42, 43) which are displaced in two directions transversely relative to each other in order to form in the hinge at least one torsional region (24; 34) which is transverse relative to the connecting direction (L).

A corresponding hinge band (5) suitable for connecting at least two links or segments of a line guide device is also proposed.

The invention generally concerns a line guide device for guiding cables, hoses or the like, including a plurality of links or segments which are preferably made from plastic and which are or can be connected to each other. The invention concerns in particular a line guide device as set forth in the classifying portion of claim 1, which includes at least one one-piece hinge.

The invention further concerns a corresponding chain link having a one-piece hinge and a hinge band having at least one such one-piece hinge.

Line guide devices like energy guide chains or cable drag devices serve for protectedly guiding cables, hoses or the like for the transmission of electric power, signals or media between a first connecting point and a relatively moveable second connecting point. Generally in that case the line guide device in a horizontally or vertically displaceable deflection region, ensures a predetermined radius of curvature which protects the lines from kinking or breaking.

In the field of such line guide devices, hinges which are produced in one piece with the parts to be connected are already known, more specifically in the form of so-called film joints, or film or foil hinges. Thus for example WO 2005/040659 A1 describes two types of one-piece hinges. Provided between two segments or links which are adjacent in the longitudinal direction are film joints or film hinges which are made in one piece with the segments. Those film hinges are formed in one piece with respective bottom elements of the individual segments, hingedly connect them together and thus serve for the pivotal movement, that is to say they provided for angular displacement of the segments relative to each other to produce a deflection arc.

WO 2005/040659 A1 also discloses one-piece hinges for opening pivotal movement of a transverse web or cover element. Those hinges in accordance with WO 2005/040659 A1 are also in the form of film hinges and are thus made in one piece with the transverse web and one of two mutually opposite side walls of the respective segment.

A further teaching relating to the production of line guide devices with one-piece hinge regions in the chain links is to be found for example in WO 98/40645 A1.

The patents EP 1 094 585 B1. or DE 600 07 260 T2 describe a one-piece chain link for an energy guide chain made of plastic. An elastically deformable hinge portion is provided, which has a recess for reducing the cross-sectional area, for pivoting the transverse web between the open and closed position.

US 2003/0145575 A1 discloses a hinge for the transverse web with two separate hinge bands, which are intended to hold the transverse web in an opened initial position.

Patent EP 1 138 555 B1 discloses a line guide device which is produced overall in one piece, with film hinges between individual segments or portions which can be angled relative to each other, of the line guide means.

Another type of line guide means is energy guide chains comprising a plurality of chain links which are hingedly connected together for example by pivot pins and corresponding receiving means.

The one-piece manufacture of hinge regions together with other component parts of the line guide device is advantageous in terms of production engineering. The complication and expenditure involved in assembly and maintenance is also generally perceptibly reduced when there are fewer individual parts. That applies for example to the one-piece production of a chain link which is U-shaped in cross-section, with a pivotably openable transverse web. A one-piece hinge connection is then required between the transverse web and the side portion.

A disadvantage however is that plastics with a comparatively low modulus of elasticity (e-modulus) are required for suitable deformability of film hinges. At the present time therefore parts with film hinges can only be produced with or from relatively elastic plastic materials, in particular with an injection moulding process. Besides the demands in terms of the plastics to be used, certain limitations are also to be observed in regard to the tool design, in particular in regard to the flow characteristics in the region of the film hinges to be produced.

Accordingly an object of the present invention is to propose a solution for hinges which are produced in one piece, which affords greater degrees of freedom in terms of manufacture, in particular in regard to the choice of material.

According to the invention that object is attained by a line guide device according to claim 1, a chain link according to claim 13, a line guide device according to claim 14 and also a hinge band according to claim 15.

In the simplest configuration, the solution according to the invention is distinguished in that the hinge produced in one piece with the parts to be connected is of a lattice-like configuration, more specifically with a plurality of material openings provided in the hinge. According to the invention those material openings are displaced in relation to each other in two directions which are transverse relative to each other, that is to say both in one direction, in particular in the connecting direction, and also transversely relative thereto. In that way the openings in the hinge form at least one torsional region which is disposed transversely relative to the connecting region. The torsional region or regions can extend in particular perpendicularly to the connecting direction.

In most cases the arrangement will involve a pure pivotal hinge in which the connecting direction in the pivoted condition follows a curvature about a notional pivot axis, that is to say in the non-curved condition the connecting direction is disposed substantially perpendicularly to the notional pivot axis. In that case the connecting direction denotes the direction in which the one-piece hinge extends, which typically but not necessarily coincides with the short main axis of the lattice-like arrangement. The hinge can also afford a certain tolerance in the connecting direction and in relation to lateral deflection, which is advantageous for example for pivotable transverse webs.

One-piece manufacture of the hinge, in the broadest sense, signifies monolithic manufacture from one piece together with the parts to be connected. That can be effected in particular by production in a common moulding or casting step, for example in an injection moulding process, or also by being shaped thereon, injected thereon or produced in some other fashion by subsequent connection involving intimate joining of the materials involved.

The proposed arrangement of openings in the region forming the hinge makes materials which are stiff, that is to say which in themselves are not particularly flexible, suitable for use for the first time in this respect. The lattice-like configuration thus first allows the monolithic hinge structure made from stiff materials.

The one-piece hinge is a flexible mechanism (commonly referred to in English as a “compliant mechanism”). It is similar in structure to a so-called curvature hinge (commonly referred to in English as a “flexure hinge”), which is known as a solid-state hinge of silicon in the microsystem technique (referred by the English abbreviation MEMS). In tests however that solution has surprisingly also proved itself to be particularly suitable for the production with hinges of reinforced plastics material. Such hinges for example of fibre-reinforced plastic afford surprisingly good results, in particular in long-term fatigue strength.

The configuration according to the invention, by virtue of the openings, produces one or more torsional regions, that is to say regions which are defined as being stressed in torsion. In that way it is possible to use markedly stiffer materials and/or greater material thicknesses (gauges) in the hinge connection. In contrast to typical film hinges the predominant basic stress in the component parts of the hinge is not a flexing but a torsion which is distributed to one or more torsional regions. The material and the dimensions are preferably so selected that the torsional regions remain in the rotationally elastic range, in every usual stress situation. Considered overall the total of a plurality of torsional deformations permits flexing of the hinge with a flexibility similar to a film hinge.

The invention permits one-piece manufacture in which the hinge is produced in substantially homogeneous form from the same material as the actual shaped parts which are to be connected, in particular one-piece manufacture from comparatively stiff plastic materials, that is to say plastic materials with a relatively high modulus of elasticity. That is made possible inter alia by virtue of the fact that, in comparison with conventional film hinges, the hinge connection does not have to be achieved by a locally pronounced weakening or reduction in the thickness of the material.

The hinge and the chain links or segments are preferably produced overall in one piece and from plastic material. However a line guide device comprising another material, for example metal sheet, would also be conceivable.

In a preferred embodiment the hinge connection and the parts to be connected are made in one piece from fibre-reinforced plastic. That is advantageous in particular for the manufacture of one-piece chain links. Thus, in spite of the hinge being integrated in one-piece form, for example for pivoting the transverse web open, a very stiff or stable chain link can be provided for high loadings, for example for an energy guide chain which is exposed to high tensile forces or requires a great chain length. In addition it is also possible for stable chain links to be produced for greater chain widths.

Mechanically advantageous conditions are achieved if the openings form a regular lattice, that is to say they are respectively based on an identical basic shape. The basic shape is preferably elongate, in particular rectangular, oval or slot-like, and desirably has a main extent transversely relative to the connecting direction of the one-piece hinge.

In a preferred embodiment the openings form through holes, that is to say they pass through the entire thickness of the material between the regions to be connected.

The openings may also not be continuous through the material or may not completely pass therethrough, for example they can be in the form of elongate blind holes. That can be advantageous for example in order to make the hinge more resistant to unwanted loadings, for example in relation to a tensile loading or lateral deflection. Openings which do not extend continuously through the material should however involve the predominant proportion (>50%) of the material thickness. That kind of opening can also be readily produced using an injection moulding process.

Good flexibility of the hinge is achieved by a plurality of and preferably at least three parallel rows of openings being provided in displaced relationship in the connecting direction. In that case each row of openings has at least one opening. An advantageous stress loading distribution is achieved if the rows of openings are arranged alternately and regularly displaced relative to each other. A displacement is particularly preferred, which is transverse relative to the connecting direction and which corresponds approximately to half the main extent of a full opening, that is to say an opening corresponding to the basic shape, which is not laterally open.

A desirable compromise between load-carrying capacity of the hinge and suitable hinge flexibility or bendability is also achieved when using particularly stiff plastic materials, if the total main extent of the openings in each row of openings is in the range of 65% to 95% of the total width of the hinge at the level of the corresponding row of openings. Particularly preferably the overall transverse dimension of the material weakening due to the individual openings is in total between 80 and 90% of the total width of the hinge at that level.

In the lattice-like configuration of the one-piece hinge, one or more connecting members which connect the torsional regions of the hinge to each other or to the parts to be connected are respectively disposed between or laterally beside the openings.

In a preferred configuration with a plurality of rows of openings, at least two connecting members are respectively disposed between each two rows of openings.

The material thickness of the connecting members between the torsional regions can be greater than or equal to the width of the connecting members. That substantially avoids bending in the region of the connecting members.

The totalled width of the connecting members between the rows of openings is preferably approximately constant in each case, whereby it is possible to achieve a uniform torsional loading in the torsional regions which are arranged in a row with each other. Similarly to the above-mentioned overall material weakening at the location of a row of openings, the totalled width of the connecting members at that location is preferably approximately between 5% and 40%, preferably in the region of 7.5% to 20% of the total width of the hinge at that location. A minimum width of the connecting members ensures a certain level of stiffness to prevent twisting of the hinge about the connecting direction.

The torsional regions can basically be of any configuration suitable for a torsional loading. Preferably however the torsional regions are each in the manner of a torsion bar, in particular of quadrangular or polygonal cross-section, wherein the dimensions of the torsion bars in the connecting direction are preferably no greater than the thickness of the material of the torsion bars. In that way it is possible to produce torsional regions which afford long-term fatigue strength, even with stiff plastic materials, in particular when using an injection moulding process.

The configuration according to the invention of the one-piece hinge permits design configurations in which the material thickness of the hinge including the torsional regions and the connecting members is substantially the same throughout. In that case the material thickness can be in particular substantially equal to the material thickness in the connecting region of the parts to be connected. That entirely avoids the material weakness in relation to wall thickness, that typically occurs when using film hinges or film joints. It is however also possible for the hinge to be made overall with a smaller wall thickness, in comparison with the parts to be connected, and at the same time to ensure torsion as constituting the main loading.

The above-mentioned features of preferred embodiments can also be applied to a chain link according to claim 13 or a one-piece line guide device according to claim 14.

In the case of a chain link with a one-piece pivot hinge for pivotal opening movement of a transverse web it may certainly be desirable if the hinge element is not torsionally resistant about the connecting axis. An energy guide chain with transverse webs which can be easily twisted about its longitudinal axis can be opened more easily with a special tool which is pulled through the internal space thereof. For that situation it is therefore advantageous if the hinge has at least three parallel rows of openings which are displaced in the connecting direction, each row having at least one respective opening, but the connection of the torsional regions between two rows of openings has only one connecting member in order to controllably permit twisting or torsion in the connecting member.

The invention also concerns a hinge band for connecting at least two links or segments of a line guide device, which is distinguished by at least one one-piece hinge according to the invention. The foregoing preferred features can also be applied to that hinge band according to claim 15. Such a hinge band is suitable for example for an energy guide chain according to WO 00/41284 A1, wherein the hinge band and the individual links are produced separately. In the case of a one-piece hinge band, in particular of plastic material, it may also be desirable to be able to use stiff materials with a modulus of elasticity which is markedly higher than the desired flexibility of the hinge band predetermines. In general however to increase the service life of such hinge bands and also in relation to line guide devices which are produced in one piece, it is advantageous to use non-reinforced plastics in the manufacture thereof.

Further details, advantages and features of the invention will be found in the description hereinafter purely by way of example of preferred embodiments. In the accompanying drawings:

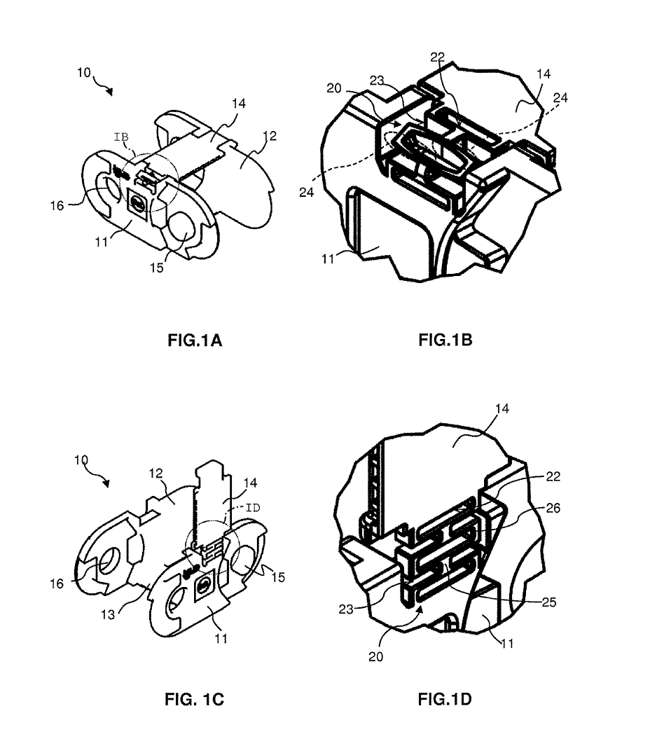

FIGS. 1A-D show a chain link produced in one piece for an energy guide chain with a hinge according to the invention for pivotal opening movement of the transverse web, in the closed condition (FIGS. 1A-1B) and in the pivoted opened condition (FIGS. 1C-1D);

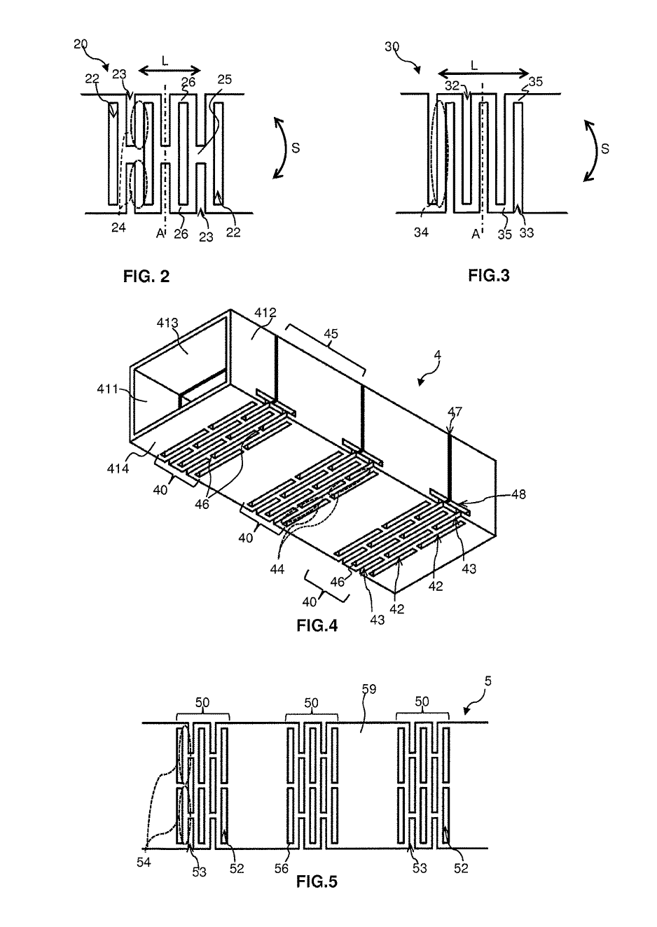

FIG. 2 shows the basic diagram illustrating the principle of a one-piece hinge, in particular for a chain link as shown in FIGS. 1A-1D,

FIG. 3 shows the basic diagrammatic view illustrating the principle of a further embodiment of a one-piece hinge according to the invention,

FIG. 4 shows a diagrammatic perspective view of a portion of a line guide device produced completely in one piece with hinges according to the invention between individual segments of the line guide device, and

FIG. 5 shows a diagrammatic plan view of a flexible hinge band suitable in particular for connecting links or segments of a line guide device.

FIGS. 1A-1D show an embodiment of an individual chain link 10. The chain link 10 is produced overall as a one-piece injection moulding, that is to say completely in one piece from plastic, in particular by an injection moulding process. The chain link 10 substantially comprises two side portions 11, 12, a first transverse web 13 and a second transverse web 14. In per se known manner the first transverse web 13 forms the rigid connection between the side portions which extend parallel in the longitudinal direction of the energy guide chain. The second transverse web 14 is pivotably mounted at one end to the side portion 11 and at the other end is latchable to the opposite side portion 12 by a suitable per se known latching connection. Thus the second transverse web 14 can be moved from the closed position shown in FIG. 1A into the opened position shown in FIG. 1C so that the internal space becomes accessible from the exterior, for example for replacing or inserting a line or conduit.

A plurality of chain links 10 are hingedly connected together by means of pivot pins and suitable receiving means 16 in order to form an energy guide chain (not shown here). In that situation the side portions 11, 12 perform the function of the side plates. The configuration of the chain link is known per se in respect of the side portions 11, 12 and the first transverse web 13, for example from DE 4313075 A1 or WO 00/63586 A1 and is therefore not described in detail here.

The chain links 10 according to the invention however differ from those known chain links by the completely one-piece manufacture thereof, that is to say both side portions 11, 12, the one transverse web 13 and the other transverse web 14 are made in one piece.

There is also a difference and substantial advantage in the plastic material which can be used for the one-piece manufacture. Because of the geometry described in detail hereinafter of the pivotal hinge at the second transverse web 14 it is possible to use a particularly stiff, reinforced plastic, in particular a fibre-reinforced plastic.

According to the invention, a particular pivot hinge 20 is provided for pivotal opening of the second transverse web 14. The second transverse web 14 is connected in one piece to the side portion 11 by the pivot hinge 20. The two side portions 11, 12, the two transverse webs 13, 14 and the pivot hinge 20 are thus produced overall in one piece from fibre-reinforced plastic.

The geometry and the mode of operation of the pivot hinge 20 are described in greater detail by means of the diagrammatic view illustrating the principle involved, in FIG. 2. FIG. 2 shows the pivot hinge 20 in the non-deformed, non-bent condition corresponding to FIG. 1D. The pivot hinge 20 extends in the connecting direction L between the parts to be connected, for example the side portion 11 and the second transverse web 14 shown in FIGS. 1A-1D.

In the flat arrangement shown in FIG. 2 the one-piece pivot hinge overall involves a structure similar to a grid or a lattice. In this case provided in the pivot hinge 20 are a multiplicity of material openings 22, 23 (hereinafter referred to for brevity as openings) in a regular pattern. The openings 22, 23 are preferably already produced by an opening in an injection moulding procedure, but they could also be produced by subsequent machining or processing.

In the illustrated example in FIG. 2 the openings 22, 23 are of an approximately rectangular contour but they could also be of a slot-shaped configuration, oval or similar. Preferably the openings 22, 23 are elongate with a main extent parallel to the notional pivot axis A (shown in broken line in FIG. 2), which is a multiple of the width in the connecting direction V. The main extent of the elongate openings 22, 23 is preferably perpendicular to the connecting direction L.

As can further be seen from FIG. 2 the openings 22, 23 are arranged approximately parallel in a row, that is to say they are disposed in rows of openings. Rows with (at least one) inwardly disposed opening 22 and two laterally open openings 23 alternate in the connecting direction L. The openings 23 are displaced transversely, preferably perpendicularly to the connecting direction L, relative to the openings 22 to produce a lattice structure in the remaining material.

Thus, by virtue of the structure of the openings 22, 23 being displaced in a lattice-like configuration, or by the displacement in two mutually transverse directions (see L and A), that gives a lattice-like structure with a plurality of torsional regions in the one-piece pivot hinge 20. Two such torsional regions 24 are marked in broken line purely by way of example in FIG. 2 and in FIG. 1B. Upon a pivotal movement which overall leads to curvature or bending of the pivot hinge 20 about the notional pivot axis A all torsional regions 24 considered in themselves are stressed primarily in torsion and not in bending. Thus, even with stiff material or with a comparatively high modulus of elasticity, it is possible to achieve suitable flexibility and good fatigue strength for the pivot hinge 20. The dimensioning, in particular the suitable longitudinal extent of the torsional regions 24 in a direction transversely relative to the connecting direction L is adjusted in dependence on the material involved.

The openings 22, 23 which are displaced in the connecting direction L and alternately in perpendicular relationship thereto produce orifices which produce remaining torsional regions 24 of a configuration similar to torsion bars. In the example shown in FIG. 2 the displacement between the openings 22, 23 in the direction transversely relative to the connecting direction L is approximately half the length of the openings 22, 23 perpendicularly to the connecting direction L. The operative twistable length of the torsional regions 24 and thus the level of flexibility can possibly be adjusted by the displacement or shift selected in terms of magnitude, transversely relative to the connecting direction L. In the case of wider hinges (see FIG. 5) for example it is also possible to adopt a ⅓ displacement or ¼ displacement instead of the illustrated ½ displacement.

The embodiment of FIG. 2 has alternately precisely one connecting member 25 or two connecting members 26 between and at the level of a row of openings 22, 23. A single connecting member 25 between adjacent torsional regions 24 allows a certain twistability about the longitudinal direction L and in particular lateral deflection, illustrated by the double-headed arrow S, that is to say about an axis perpendicularly to the plane of the drawing in FIG. 2. That further degree of freedom is advantageous in relation to chain links as shown in FIGS. 1A-1D in order to be able to pivot open many transverse webs 14 with a so-called opening aid in one working step, without damaging the hinge 20.

Preferably the totalled width of two connecting members 26 is approximately identical to the width of the individual connecting member or the total width of the connecting members 25, 26 in the transverse direction is approximately constant over the connecting length L to achieve a uniformly distributed torsion of the torsional regions 24. The torsional regions 24 in the form of torsion bars on the other hand are preferably of a dimension in the connecting direction L which at most is immaterially greater than the material thickness thereof (thickness in the plane measured perpendicularly to FIG. 2), particularly preferably a dimension in the connecting direction L, which is equal to or less than the material thickness. It is possible in that way to produce torsional regions 24 in bar form or quadrangular form, which can be particularly satisfactorily twisted or which are rotationally elastically deformable.

As can best be seen from FIG. 1D the material thickness is preferably constant throughout over the dimension of the one-piece pivot hinge 20 and can be for example identical to or of substantially the same magnitude as the material thickness of the openable transverse web 14. The remaining width of the connecting members 25 and 26, considered in a direction perpendicularly to the connecting direction L, is preferably so selected for good flexibility of the pivot hinge 20, that it is at most 20%, in the case of particularly flexurally stiff material, at most 10%, of the total width of the hinge 20 (considered at a location along the connecting direction L). The flexibility and long-term fatigue strength of a hinge 20 of the structure shown in FIGS. 1A-1D or FIG. 2 respectively was found in tests to be surprisingly good, which under some circumstances could be attributed to the flow characteristics in the injection moulding process and the resulting fibre orientation.

FIG. 3 shows a further embodiment according to the invention of a one-piece hinge 30 which is also flexible in the manner of a pivot hinge about the notional pivot axis A. The hinge 30 can also be used in use situations in which greater lateral flexing or deflection S (note: suitably correct torsion above) (in the plane in FIG. 3) or a certain stretching or upsetting compression effect in the connecting direction L is desirable.

In FIG. 3 the deformable region of the one-piece hinge 30 is provided with a meander-like lattice structure. In this case openings 32 which are open towards one side alternate with openings 33 which are open towards the other side. Accordingly, provided between the respective torsional regions 34 there is in each case only precisely one connecting member 35. That one-piece hinge 30 affords greater flexibility in all directions, in comparison with the hinge 20 shown in FIG. 2. It is thus overall less resistant in relation to unwanted deformation effects. Similarly to the hinge 20 in FIG. 2, sufficiently good flexibility about the notional pivot axis A is also ensured in the case of the hinge 30 in FIG. 3, by the provision of at least three parallel rows, displaced in the connecting direction L, with openings 22, 23 and 32, 33 respectively, even when using particularly stiff material, like for example fibre reinforced plastic. In the case of the hinge 30 shown in FIG. 3 the main extent of the openings 32, 33 is also preferably in the region of 80% to 90% of the overall width of the hinge 30.

FIG. 4 shows the use of pivot hinges 40 according to the invention for hingedly connecting individual adjacent segments 45 of a line guide device 4, in such a way that the connection can be set at an angle. The line guide device 4 is overall in one piece portion-wise or completely, wherein each segment 45 comprises a box-like configuration consisting of parallel side portions 411, 412 and transverse webs 413, 414 connecting same.

The line guide device 4 can be made from particularly stiff plastic by means of the pivot hinges 40. The pivot hinges 40 form a one-piece connection of the transverse webs 414 of two adjacent segments 45 in the bottom region (at the inside in the deflection arc configuration). The pivot hinges 40 are centrally centred at the location of separating gaps 47. The separating gaps 47 which extend over the full periphery respectively form the junctions between two adjacent segments 45. The configuration of each of the individual pivot hinges 40 is identical. They correspond to the principle of a regular lattice structure with elongate openings 42, 43 which alternate in a ½ displacement, similarly to FIG. 2. The pivot hinges 40 pivotably connect respective adjacent segments 45 in such a way that the segments 45 can be pivoted or angled relative to each other about a notional pivot axis (not shown in greater detail here) to permit a displaceable deflection arc. A transverse gap 48 is provided in each case between the pivot hinge 40 and the separating gap 47, for better pivotability.

In the pivot hinges 40 shown in FIG. 4, in contrast to FIG. 2, the torsional regions 40 however are always connected by at least two connecting members 46. It is thus possible to avoid lateral deflection or twisting about the connecting direction or longitudinal direction of the line guide device 4.

Pivot hinges 40 operating on the principle of FIG. 4 can thus be used to improve a line guide device which is made in one piece, for example as disclosed in WO 2005/040659.

FIG. 5 shows a flexible hinge band 5 which can basically be used independently of the above-indicated examples, for hingedly connecting parts. Such a hinge band 5, for example of fibre reinforced plastic or metal sheet, can be used in particular for improving a so-called band chain in which individual chain links are connected together by the hinge band 5 to constitute a flexible bendable energy guide chain. For that purpose the hinge band has one-piece pivot hinges 50 which for example are designed in accordance with the principle shown in FIG. 4. Solid hinge band portions 59 without material openings are disposed between the pivot hinges 50. Alternatively a hinge band provided throughout with the regular pattern in respect of the openings is also in accordance with the invention.

Line guide device with one-piece hinge, a corresponding chain link and a hinge band

### LIST OF REFERENCES

### FIGS. 1A-1C

10 chain link
11, 12 side portions
13 first transverse web
14 second transverse web
15 pivot pin
16 receiving means
20 pivot hinge
24 torsional region (example)

### FIG. 2

20 pivot hinge
22, 23 openings
24 torsional region (example)
25 connecting member
A pivot axis
L connecting direction
S deflection

### FIG. 3

30 pivot hinge
32, 33 openings
34 torsional region (example)
35 connecting member
A pivot axis
L connecting direction
S deflection

### FIG. 4

4 line guide device
40 pivot hinge
411, 412 side portions
413, 414 transverse webs
42, 43 openings
44 torsional region
45 segment
46 connecting member
47 separating gap
48 transverse gap

### FIG. 5

5 hinge band
50 pivot hinge
52, 53 openings
54 torsional region
59 hinge band portion

1. A line guide device for guiding cables, hoses or the like, including a plurality of links or segments which are or can be connected together and are made from plastic, and at least one one-piece hinge, in particular for pivotably connecting
two links or segments together, which are adjacent in the longitudinal direction and which are pivotable or can be angled relative to each other by the hinge; and/or
two parts of a link or segment, in particular a transverse web which is connected to a side portion by the hinge in such a way that it can be pivoted open,
characterised in that the one-piece hinge is of a lattice-like structure with a plurality of openings, which are displaced in two directions transversely relative to each other, in order to form at least one torsional region, which is disposed transversely relative to the connecting direction, in the hinge.

2. A line guide device according to claim 1 characterised in that the openings by virtue of an identical basic shape form a regular lattice, wherein the basic shape is elongate, in particular rectangular, oval or slot-like, with a main extent transversely relative to the connecting direction.

3. A line guide device according to claim 1 characterised in that the openings form through holes.

4. A line guide device according to claim 1, characterised in that there are provided at least three parallel rows of openings which are displaced in the connecting direction and each having at least one opening.

5. A line guide device according to claim 4 characterised in that the openings are displaced alternately and regularly relative to each other, with a displacement transversely relative to the connecting direction of approximately half the main extent of a full opening.

6. A line guide device according to claim 4, characterised in that disposed between two rows of openings respectively are at least two connecting members which connect torsional regions to each other or to the parts to be connected.

7. A line guide device according to claim 6 characterised in that the material thickness of the connecting members is greater than or equal to the width of the connecting members.

8. A line guide device according to claim 6 characterised in that the totalled width of the connecting members between the rows of openings is respectively approximately constant.

9. A line guide device according to claim 1, characterised in that the torsional region or regions is or are each in the manner of a torsion bar, of a dimension in the connecting region not greater than the material thickness.

10. A line guide device according to claim 1 characterised in that the thickness of the hinge is substantially constant, in particular substantially equal to the material thickness in the connecting region of at least one of the parts to be connected.

11. A chain link for an energy guide chain for guiding cables, hoses or the like, comprising a plurality of chain links which are or can be connected together, wherein the chain link is made from plastic and has two side portions, a first transverse web fixedly connecting same, and a second transverse web which is connected to one of the side portions by a one-piece hinge in such a way that it can be pivoted open,
characterised in that the one-piece hinge is of a lattice-like structure with a plurality of openings, which are provided in the hinge and which are displaced in two directions transversely relative to each other, in order to form at least one torsional region, which is disposed transversely relative to the connecting direction, in the hinge.

12. A line guide device according to claim 11 characterised in that at least one one-piece hinge is made from fibre-reinforced plastic, in particular in one piece with the link or segment.

13. A chain link according to claim 11 characterised in that there are provided at least three parallel rows of openings that are displaced in the connecting direction, each having at least one respective opening, and only one connecting member which connects the torsional regions is disposed at the location of a row of openings.

14. A line guide device for guiding cables, hoses or the like, including a plurality of segments made in one piece from plastic material, wherein two respective segments are connected together by a hinge which is made in one piece with the segments, and said segments can be angled relative to each other,
characterised in that the one-piece hinge is of a lattice-like structure having a plurality of openings, which are provided in the hinge and which are displaced in two directions transversely relative to each other, in order to form at least one torsional region, which is disposed transversely relative to the connecting direction, in the hinge.

15. A hinge band, in particular for connecting at least two links or segments of a line guide device for guiding cables, hoses or the like,
characterised in that the hinge band has at least one one-piece hinge which is of a lattice-like structure having a plurality of openings, which are provided in the hinge and which are displaced in two directions transversely relative to each other, to form in the hinge at least one torsional region, which is disposed transversely relative to the connecting direction, in the hinge.
